(19) United States
(12) Patent Application Publication
(10) Pub. No.: US 2001/0034630 A1
(43) Pub. Date: Oct. 25, 2001

(54) Interactive employment system and method

(75) Inventors: Juliana Mayer, San Francisco, CA (US); Steven Spieczny, San Francisco, CA (US); David Schmidt, San Francisco, CA (US); Sparky Wilson Rose, San Francisco, CA (US)

Correspondence Address: DARBY & DARBY P.C., 805 Third Avenue, New York, NY, 10022, US

(73) Assignee: Robert Half International, Inc.

(21) Appl. No.: 09/839,502

(22) Filed: Apr. 20, 2001

Related U.S. Application Data
(60) Provisional application No. 60/199,038, filed on Apr. 21, 2000.

(51) Int. Cl. G06F 17/60

(52) U.S. Cl. 705/7

(57) ABSTRACT

A method and system for matching candidates to available job positions is implemented in a network environment, such as the Internet. A web server is provided to store searchable candidate and job profiles. Candidates can search for available job openings and store their personal profiles in a database maintained by the web server. The personal profiles may be entered through one or more predefined templates having fields related to specific candidate profile information. Employers may conduct searches of the candidate profile database to find one or candidates who match particular job criteria. Matching candidate information may be presented to the employer in response to a search query. Identification data, such as a name, an address or current employer of a particular candidate, may be rendered inaccessible to the employer until a fee is paid. Fees will be charged based on the number of candidates whose personal information is requested by an employer after a search has been made, rather than being based on the number of candidates who match the search criteria.

### BACKGROUND OF THE INVENTION

1. Field of the Invention

The present invention relates to data processing for business methods, and relates more particularly to interactive systems and methods for matching candidates to available job openings.

2. Description of the Related Art

With increasing frequency, the Internet is being used to match job candidates and employers.

There were approximately 40 million job placement transactions which took place in the United States in 1999. It is estimated that about 10% of these transactions involved the Internet in some manner, e.g., a candidate finding a job posting online, or an employer finding one or more candidates online. With the prospects of increasing economic growth coupled with the surging popularity of the Internet, it has been estimated that the number of job transactions may increase to 48 million by 2003, with a corresponding increase in web-assisted transactions to 40% or more of all such job transactions.

In typical configurations, a web hosting site or other type of addressable network device, allows candidates to store information relating to their education, employment history, job skills, personal references and the like. Candidates may also search listings of available job openings. These sites additionally allow employers to search through profiles of a plurality of candidates to find those with desirable characteristics.

In order to generate revenue, a company which hosts a job-placement web site typically charges employers a subscription fee or a flat fee to post available job listings for a pre-defined period of time and to search the site. Candidates, typically, are not charged a fee to store their profile information or to search stored job listings. However, banner adds and the like are usually placed on the site to generate advertising revenues that are generally dependent upon the number of ‘hits’ a web site receives over a predetermined time. Candidates typically greatly outnumber the number of employers who access a job placement site. Thus, candidates who access the web site provide a source of revenue by generating hits, even though they are not charged subscription or transaction fees.

While this has been the predominant business model for job-placement web sites of the prior art, a subscription or flat fee rate may be unfair to certain employer-subscribers. For example, a particular employer who subscribes to a job-placement web site may find that the site does not attract a substantial number of qualified or desirable candidates in a particular field of interest. Such an employer-subscriber might then decide that the subscription fees are unjustified or an inefficient allocation of resources and thus, may choose to discontinue subscribing to the site.

Accordingly, there is a need for an interactive employment system and method which generates revenue on the basis of the number of qualified candidates that employers actually find through the use of a job-placement web site. It would be furthermore preferable to charge employers only for those candidates with whom they are particularly interested, rather than charging for all candidates that match a particular job description. In this manner, more employers may choose to continue using a job placement web site incorporating this business model, since the amount of money they are charged is proportional to the number of suitable and desirable candidates that the employer finds through the site.

### BRIEF SUMMARY OF THE INVENTION

In order to address and solve certain of the foregoing shortcomings in the prior art, the present invention provides an interactive employment system which allows a candidate to enter profile data, including identification data, and to match their criteria and then view available job postings. The system further allows an employer to search profile data corresponding to a plurality of candidates and returns search results corresponding to candidates who match the search criteria. The search results can include a percentage match between each profile and the search criteria. The system can also withhold identification data corresponding to each candidate, such as the name and/or contact information for each candidate. After search results have been displayed, the employer can review certain portions of each candidate's profile data, such as previous and current job experience, positions held, education level, and the like. The employer can then provide or authorize a payment for each candidate for whom the employer would like to receive the identification data, so that they may contact the candidate through their normal hiring process.

Upon submitting profile and identification data, candidates can specify that certain employers are to be excluded from receiving the identification data altogether. When non-excluded employers receive a candidate's profile, the candidate can be contacted via e.g., an e-mail message, a written letter which is generated and sent to an address designated by the candidate, a facsimile notification, an instant message transmitted to the candidate's browser, and the like.

Further features of the present invention include allowing the candidate to undertake a general skills test in which the candidate answers specific questions. The answers, in turn, may be used to generate a ranking or grading of the candidate. An employer can receive the ranking report for a candidate who undertakes the skills test in exchange for an additional fee.

In one embodiment, a candidate can further enroll in online training programs, such as a continuing education program, specific software application training and the like, to increase the candidate's skill set. A fee to participate in such online training can be charged. For a further fee, the web host or a third party can administer a test of the candidate's skill level related to the received training and provide the results of this test to interested employers upon payment of a fee.

The web site host can charge further fees for providing background checks, such as criminal history checks, credit checks and driving histories for a particular candidate. The web site host may also charge a fee to employers for the provision of payroll and other administrative services for a particular candidate.

### BRIEF DESCRIPTION OF THE SEVERAL VIEWS OF THE DRAWINGS

Further aspects of the instant invention will be more readily appreciated upon review of the detailed description of the preferred embodiments included below when taken in conjunction with the accompanying drawings, of which:

FIG. 1 is a block diagram of an exemplary network system for accessing a server which matches candidates to available job openings;

FIG. 2A is a schematic block diagram of exemplary components of a remote terminal of FIG. 1;

FIG. 2B is a schematic block diagram of exemplary components of the server of FIG. 1;

FIG. 3A is an exemplary candidate profile database stored by the server of FIG. 2B;

FIG. 3B is an exemplary job profile database stored by the server of FIG. 2B; and

FIG. 4 is a flowchart illustrating exemplary steps for locating an available job opening and suitable candidate according to one embodiment of the present invention.

### DETAILED DESCRIPTION OF THE PREFERRED EMBODIMENT

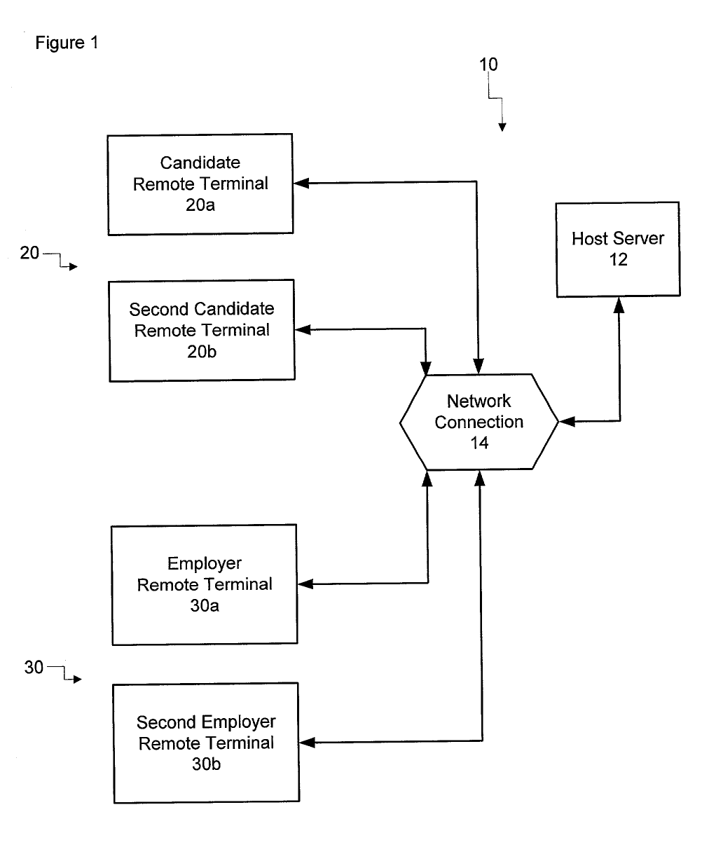

Referring now to FIGS. 1-4, wherein similar components of the instant invention are referenced in like manner, a preferred apparatus for matching candidates to available job openings and accompanying methods for using the same are disclosed.

Turning now to FIG. 1, depicted therein is an exemplary computer network 10 through which remote devices 20, 30 may communicate with one or more host servers 12 via network connection 14 in any known manner. Although computer network 10 is preferably an Internet-based network, it can be also a local area network (LAN), a wide-area network (WAN), an intranet environment, an extranet environment, a broadband wireless network or other type of computer or communications network, such as those enabled over public switched telephone networks. Remote devices 20, 30 may be any computing device, such as a personal computer, a workstation, a network terminal or any other device that can communicate with central server 12 over the network connection 14. Remote devices 20, 30 include one or more candidate remote terminals 20a, 20b and one or more employer remote terminals 30a, 30b as described further herein below. Server 12 may include any number of computer servers which cooperate to maintain the system of the present invention and perform the methods for using the same.

In one embodiment of server 12 maintains a web site which is hosted on the Internet. A candidate or employer communicates with the server 12 through remote terminals 20, 30 which can be equipped with hardware and software that accommodates Internet access over network connection 14.

Alternatively, the server 12 can host a bulletin board site or a separate community of network servers, such as those maintained by AMERICA ONLINE. In that case, a candidate or an employer communicates with the server 12 by dialing directly into the server 12 using the appropriate remote terminal 20, 30 which, in turn, can be equipped with a modem or the like that can transmit and receive data over a public switched telephone network. Other variations and configurations of computer network 10 will be apparent to one of ordinary skill in the art.

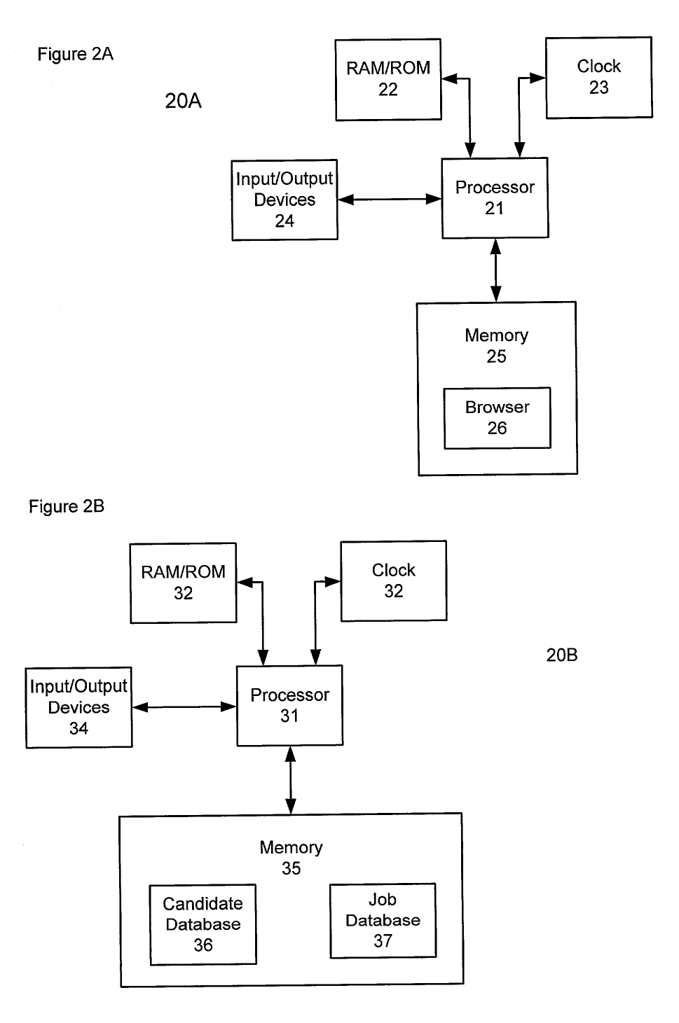

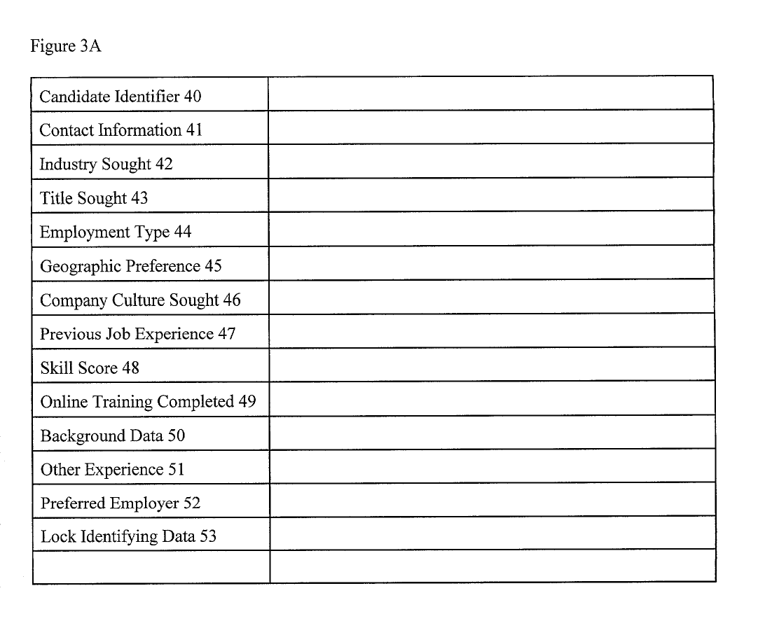

Turning now to FIG. 2A, displayed therein are exemplary components of a remote terminal, such as a candidate remote terminal 20a or an employer remote terminal 30a (FIG. 1), which can be used to implement the present invention. Although the descriptions below are applicable to either type of terminal, the components will be discussed with regard to candidate terminals 20 only for the sake of brevity.

The primary component of customer terminal 20a is a processor 21, which can be any commonly available microprocessor, such as the PENTIUM III manufactured by INTEL CORP. The processor 21 may be operatively connected to further exemplary components, such as RAM/ROM 22, a clock 23, input/output devices 24, and a memory 25 which stores one or more operating system and application programs, such as browser 26.

The processor 21 operates in conjunction with random access memory and read-only memory in a manner well known in the art. The random-access memory (RAM) portion of RAM/ROM 22 can be a suitable number of Single In-line Memory Module (SIMM) chips having a storage capacity (typically measured in kilobytes or megabytes) sufficient to store and transfer, inter alia, processing instructions utilized by the processor 21 which can be received from the browser program 26. The read-only memory (ROM) portion of RAM/ROM 22 can be any permanent non-rewriteable memory medium capable of storing and transferring, inter alia, processing instructions performed by the processor 21 during a start-up routine of the customer terminal 20a. Further functions of RAM/ROM 22 will be apparent to one of ordinary skill in the art.

The clock 23 may be an on-board component of the processor 21 which dictates a clock speed (typically measured in MHZ) at which the processor 21 performs and synchronizes, inter alia, communication between the internal components of customer terminal 20a. Further functions of the clock 23 will be known to one of ordinary skill in the art.

The input/output device(s) 24 can be one or more commonly known devices used for receiving operator inputs, network data, and the like and transmitting the same to the user or to host server 12.

Accordingly, exemplary input devices may include a keyboard, a mouse, a voice recognition unit and the like for receiving user inputs.

Output devices may include any commonly known devices used to present data to an operator of central server 12 or to transmit data over the computer network 10. Accordingly, suitable output devices may include a display, a printer and a voice synthesizer connected to a speaker.

Other input/output devices 24 may include a telephonic or network connection device, such as a telephone modem, a wireless modem, a cable modem, a T- 1 connection, a digital subscriber line or a network card, for communicating data to and from other computer devices over the computer network 10.

The memory 25 may be an internal or external large capacity device for storing computer processing instructions, computer-readable data, and the like. The storage capacity of the memory 25 is typically measured in megabytes or gigabytes. Accordingly, the memory 25 may be one or more of the following: a floppy disk in conjunction with a floppy disk drive, a hard disk drive, a CD-ROM disk and reader/writer, a DVD disk and reader/writer, a ZIP disk and a ZIP drive of the type manufactured by IOMEGA CORP., and/or any other computer readable medium that may be encoded with processing instructions in a read-only or read-write format. Further functions of and available devices for memory will be apparent to one of ordinary skill in the art.

The memory 25 may store, inter alia, a plurality of programs (not shown) which may include, for example, an operating system such as WINDOWS NT by MICROSOFT CORP. The memory 25 may further store one or more application programs which are necessary to implement the embodiments of the present invention, such as a web browser, e.g. NETSCAPE COMMUNICATOR, for allowing a candidate to view web page information. Memory 25 may contain further programs which contain processing instructions for implementing the methods disclosed herein.

Employer remote terminals 30 may be of a similar configuration to candidate remote terminals 20. Employer remote terminals 30 may further be any computing device capable of transmitting information to and receiving information from server 12.

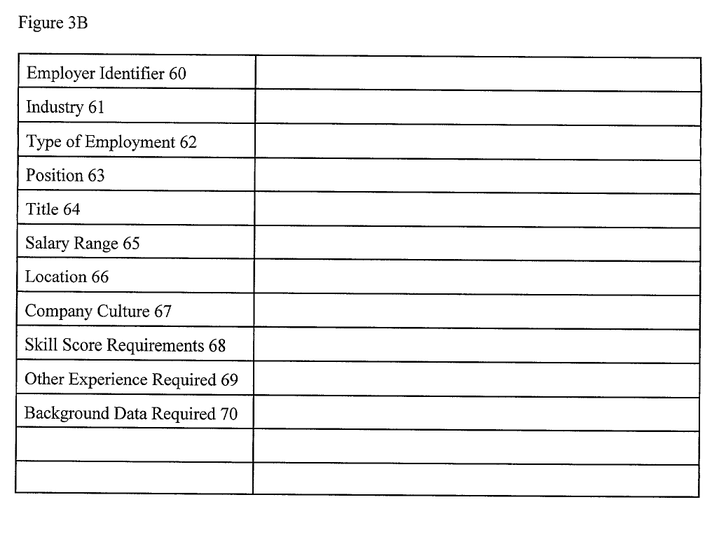

Turning now to FIG. 2B, depicted therein are exemplary components of a host server 12 which may be necessary to implement the present invention. Server 12 can be any one or more network or web server devices which are operative to communicate with a plurality of remote terminals 20, 30 over the computer network 10. Accordingly, server 12 can include a processor 31, RAM/ROM 32, a clock 33, input/output devices 34, and a memory 35 which may store one or more operating system and applications programs. Server 12 preferably stores a database program which maintains one or more databases, such as candidate profile database 36 and a job profile database 37, as described further herein below with respect to FIGS. 3A and 3B. Processor 31, RAM/ROM 32, clock 33, and the operating system programs may be similar in functionality to processor 21, RAM/ROM 22, clock 23 and the operating systems described above with respect to FIG. 2A. Input/out devices 34 may likewise have similar functionality to devices 24 discussed with respect to FIG. 2. However, it is preferable that any network or communication devices used as input/output devices 34 be of the type that can handle high bandwidth or large amounts of network traffic as is consistent with the operation of an Internet web server and the like.

The database program may be any large volume data management software, and is preferably an SQL-based relational database management program of the type manufactured by ORACLE. The database program stores candidate profile data, job profile data and the like as described further below with respect to FIGS. 3A and 3B.

Further application programs can include processing instructions for allowing the host server to administer skill tests, conduct background checks with third party web hosting services, and the like.

Further programming of the server 12 can allow grading of candidates' answers to administered test, which in turn can be used to generate a ranking or grading of the candidate. An employer may be required to pay a fee to receive the ranking report.

In one embodiment, server 12 is configured to allow a candidate to enroll in online training programs (such as a continuing education program, specific software application training and the like) to increase the candidate's skill set. Candidates may be charged a fee to participate in such online training. For a further fee, the web host or a third party could administer a test of the candidate's skill level. The results of the test could be provided to interested employers, e.g., upon payment of a fee.

The web site host can charge further fees for providing background checks, such as criminal history checks, credit checks and driving histories for a particular candidate. The web site host may further charge a fee and be programmed to provide payroll and other administrative services for a particular candidate.

It is preferred that the host server 12 can direct any remote computing devices 20, 30 to display an appropriate interface, such as one or more pre-formatted web pages so that a user, such as a candidate or an employer can interact with the server 12. Accordingly, after a candidate or an employer logs into the server, that user is presented with an introductory web page, which may be written in HTML, XML, JAVA Script, and the like.

Referring now to FIG. 3A, therein is depicted an exemplary format for a candidate profile database 36 managed by server 12, wherein titles of individual fields 40-53 are presented. Further or fewer fields may be provided as will be appreciated by one of ordinary skill in the art. In addition, field titles may be altered from those presented in FIG. 3A without impacting the spirit and scope of the present invention. Furthermore, alternative data structures, other than standard database formats may be employed.

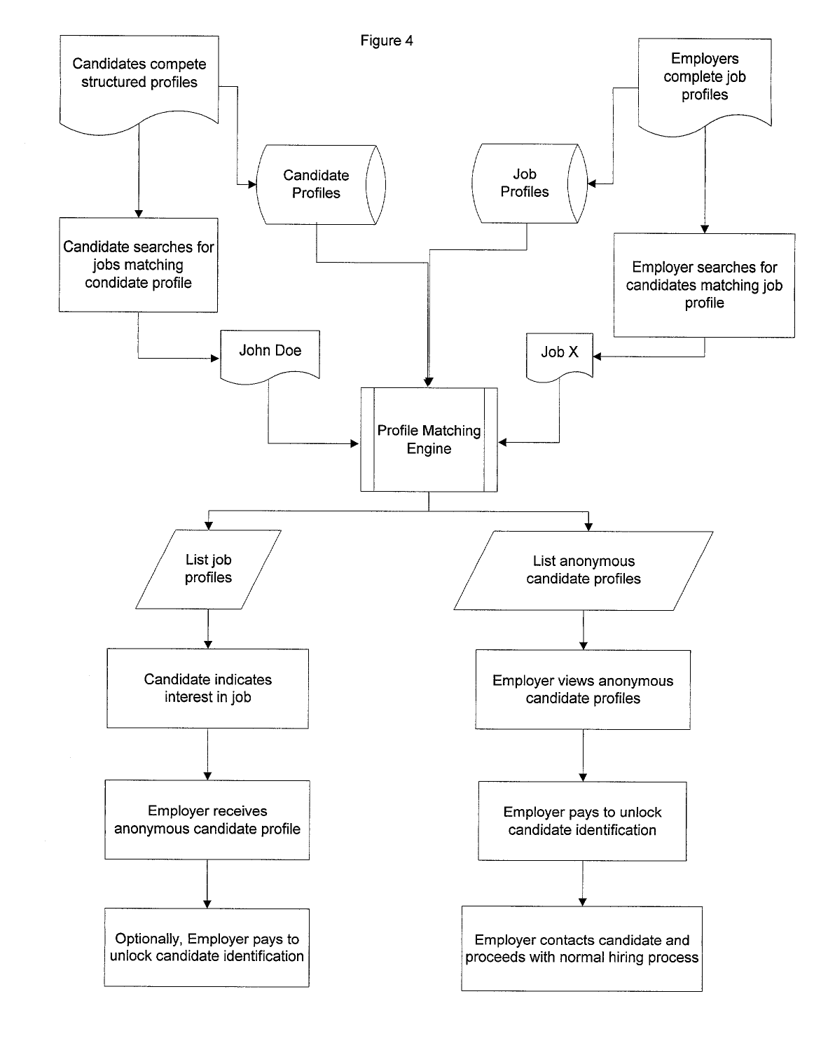

Any of the following fields may be searched by a prospective employer in accordance with the present invention, as described below with respect to FIG. 4. Data can be entered into the database 36 by a candidate accessing the server 12 via a remote terminal 20a. A pre-formatted web page, which may be similar in appearance to FIG. 3A, may allow the candidate to enter appropriate information which is then inserted into the corresponding fields of database 36. Alternatively, a candidate can submit data an alternate format, such as a resume stored in a word processing format. The alternate format may contain some or all of the data described below, in which case, the data may be parsed by server 12 and inserted into the appropriate fields of candidate profile database 36, in any manner known to one of ordinary skill in the art.

Candidate identifier field 40 preferably contains a name or other identifier of each candidate who submits profile data to server 12. The information stored in candidate identifier may be initially locked by the system until an interested employer has paid a fee for the information to be revealed, as described further below.

Contact information field 41 may store information on how to contact the corresponding candidate. Accordingly, field 41 may contain, a home address, a home telephone number, a cellular or digital telephone number, a pager number, an e-mail address and the like. Like field 40, the information in this field may be locked until appropriate fees have been paid by an interested employer.

Industry field 42 preferably allows a candidate to enter the industry in which he or she is interested in seeking employment. The candidate may select data from a group of predetermined terms or may enter his or her own descriptions. Examples of appropriate industries include accounting, finance, banking, brokerage, insurance, computers, information technology, medical and nursing. Other types of industry descriptors may additionally be used.

Title sought field 43 preferably allows the candidate to enter the title of the position in which he or she is interested. The candidate may select data from a group of predetermined terms or may enter his or her own descriptions. Examples of appropriate titles include ‘office administrator,’ ‘account specialist’ and ‘computer programmer.’ Other appropriate job titles may additionally be used.

Employment type field 44 preferably allows the candidate to enter the type of employment in which he or she is interested. Appropriate types of employment include temporary positions, permanent positions, contract positions, and temp-to-perm positions. Other appropriate employment types may also be entered and stored.

Geographic preference field 45 preferably allows the candidate to enter the physical location or locations in which he or she is interested in working. The candidate may select from a group of predetermined locations or may enter his or her own descriptions of geographic preference. Examples of appropriate data to be entered in this field include a domestic region (i.e. Northeastern United States), a city, a state, a zip code or a telephone area code. International locations may be further specified, such as a continent, a foreign country or a foreign city. Other appropriate descriptions of geographic locations may likewise be used.

Company culture field 46 preferably allows the candidate to enter the type of corporate environment in which he or she is interested. The candidate may select data from a group of predetermined terms or may enter his or her own description. Examples of appropriate information for this field includes ‘formal,’ ‘informal,’ ‘start-up’ and the like. Other appropriate descriptions may be used.

Previous job experience field 43 preferably allows the candidate to enter information about previous job positions he or she has held. Examples of appropriate information include a description of duties, a job title, and dates of employment for one or more current or previous positions in which the candidate has been employed. Information from this field may be verified with third parties and the like by the operator of host server 12 upon payment of a fee by either the candidate or an interested employer. Information entered into this field may instead be entered into multiple, separate fields without departing from the spirit and scope of the invention.

Skill score field 48 preferably stores an evaluation of the candidate based on one or more skill tests completed online or through a third party. Interested employers may be charged a fee to access the information stored in this field. Examples of appropriate skill tests include a determination of the number of words per minute a candidate is able to type, or a determination of the candidates proficiency with a particular software program.

Online training field 49 preferably stores a listing of online training completed by the candidate.

Examples of online training that may be offered include training for a particular software program and the like. In one embodiment of the present invention, an interested candidate may pay the operator of host server 12 to complete online job training. Additionally, an employer may pay to view which online training programs a candidate has completed.

Background data field 50 preferably stores background information concerning a candidate.

Examples of such background information include a criminal background check, a credit check or a driving history of the candidate. The information may be obtained by the operator of host server 12 from one or more third party verification companies. In one embodiment of the present invention, this background information may be provided to interested employers upon payment of a fee.

Other experience field 51 preferably allows the candidate to enter educational information, military experience and the like. The candidate may enter information into this field from a group of predetermined terms or may enter his or her own description. Other appropriate data may additionally be entered and stored.

Preferred employer field 52 preferably allows the candidate to enter one or more companies for which he or she is interested in working. The candidate may select from a group of predetermined companies (e.g. companies that are registered with the host server 12) or may enter additional companies.

Lock identifying data field 43 preferably allows the candidate indicate that certain employers are to be prevented from receiving the candidate's identifying data (e.g. candidate identifiers and contact information) without the candidate's permission. The candidate may further specify certain companies that are to be always prevented from receiving the identifying data, such as the candidate's current employer.

There may be a further provision of fields which allow candidates to store, for example, preferred salary ranges and the like which a matching job profile should contain.

Referring now to FIG. 3B, therein is depicted an exemplary format for a job profile database 37 maintained by server 12, wherein titles of individual fields 60-70 are presented. Further or fewer fields may be provided as will be appreciated by one of ordinary skill in the art. In addition, field titles may be altered without impacting the spirit and scope of the present invention. Furthermore, alternative data structures, other than standard database formats, may be employed.

Any of the following fields may be searched by a candidate in accordance with the present invention, and as described below with respect to FIG. 4. Data may be entered into the database 37 by 10. an employer accessing the server 12 via a remote terminal 30a. A pre-formatted web page, which may be similar in appearance to FIG. 3B, may allow the employer to enter appropriate information which is then inserted into the corresponding fields of database 37.

Employer identifier field 60 may contain a name of an employer, such as a corporate name, a trade name and the like. Industry field 61 preferably contains an indication of the industry in which the company has an available job. Examples of appropriate industries have been provided above in the discussion of field 42.

Type of employment field 62 preferably contains information as to the type of position available, e.g. temporary, permanent, contract or temp-to-perm.

Position field 63 preferably contains a description of the duties that a candidate would have to perform for a particular job listing.

Title field 64 preferably contains the title which accompanies an available job listing.

Salary range field 65 preferably contains a salary for the available job listing being entered.

Location field 66 preferably describes the physical location in which the job is situated, e.g. city and state.

Company culture field 67 preferably contains a description of the employer's working environment, e.g. informal, formal, start-up and the like.

Skill score requirements field 68 preferably contains a range of skill scores which candidates should achieve to be considered for the position, e.g. a candidate must type at least 60 words per minute.

Other experience required field 69 preferably contains a description of other experience which an employer would like a candidate to possess, in addition to those mentioned above.

Background data required field 70 preferably contains a description of the background data required for a candidate to be considered for a position, e.g. a candidate must not have had any speeding tickets in the past two years.

Referring now to FIG. 4, therein is depicted an exemplary process by which a candidate submits profile data and performs a job search on server 12. The process commences when a candidate optionally enters and stores profile data to server 12 (step 80). The profile data can include the information described above with respect to FIG. 3A and stored in candidate profile database 36.

A candidate next enters one or more database search terms for a position the candidate desires (step 81). The search terms can be based on the candidate's profile data which was stored at step 80 (e.g., the candidate's entry of a preferred employer or a preferred salary range may automatically be 15; incorporated into the search), or the search may include new criteria entered by the candidate. Server 12 is preferably programmed to accept the search data and apply it to the job profile data stored in the job profile database 37.

The server 12 then presents the candidate with results of the database search that was requested (step 82). All positions which have any matching data can be presented. Additionally, any matching job profiles may be ranked according to the percentage of search terms that have been matched to the candidate's search request. Other methods of presenting search results may likewise be used.

The candidate can then indicates that he or she is interested in a particular job listing that has been provided with the search results (step 83). This may be accomplished, for example, by providing a location on the web page, such as a virtual button or checkbox, which the candidate could activate to indicate interest in the job listing and even apply for the job online. Upon selecting the listing, the employer is notified that a candidate has indicated interest in the available job and the employer receives at least a portion of the candidate profile. Preferably, identifying data corresponding to the candidate is initially withheld (step 84).

After reviewing the received profile data, the employer may choose to unlock the candidate's identity (step 85). This may be accomplished, for example, by charging the employer a fee to be paid to the operator of the web site to receive the candidate's identifying data, such as the data stored for the candidate in the candidate identifier field 40 and the contact information field 41 of the candidate profile database 36. After payment of the fee and after receiving the identification data, the employer may process the candidate through that company's normal hiring process (step 95).

Referring now to FIG. 4, therein is depicted an exemplary process by which an employer may submit job profile data and perform a search of acceptable candidates for a job position on server 12.

The process commences at step 90 where an employer enters job profile data for an available job opening. The data may be stored in job profile database 37. The employer may can then conduct a search for possible candidates for a job position by entering search criteria at the web site hosted by server 12 (step 91). The search criteria may incorporate some or all of the data entered above at step 90.

The server then compares the entered search criteria to the candidate profiles stored in candidate profile database 36.

The server next lists candidates who match the entered search criteria (step 92). All candidates with matching search terms may be listed. The list of matching candidates may be sorted according to the percentage of search terms that match each candidate. Furthermore, identification and contact data corresponding to each candidate may be withheld, while other profile data stored in database 36 is presented for review by the employer.

The employer may then select those candidates for which the employer would like to receive identification and contact data. The employer may then pay a fee to unlock the identification and contact data (step 94). The fee may correspond to the number of candidates in which the employer is interested. If a candidate whose data matches the employer's search terms has designated that the employer is not to receive identification and/or contact data, that data may be withheld from the employer. In such case, a fee may not be charged for the employer's request to unlock that candidate's identification and contact data. The employer search process concludes at step 95, discussed previously above.

Although the invention has been described in detail in the foregoing embodiments, it is to be understood that they have been provided for purposes of illustration only and that other variations both in form and detail can be made thereupon by those skilled in the art without departing from the spirit and scope of the invention, which is defined solely by the appended claims.

We claim:

1. A method for matching candidates to available job openings, comprising:
a. storing candidate profile data corresponding to a plurality of candidates, the candidate profile data including identification data corresponding to each candidate;
b. receiving a search request from an employer to be applied to the candidate profile data;
c. displaying a search result to the employer, the search result including a listing of at least one matched candidate having candidate profile data that corresponds to a portion of the search request and excluding identification data for each matched candidate;
d. receiving, from the employer, a request to receive identification data for at least one matched candidate; and
e. charging a fee to the employer based on the request to receive identification data.

2. The method of claim 1, further comprising the steps of
a. comparing each candidate profile to the search request;
b. determining a match when at least a portion of the candidate profile satisfies the search request; and
c. compiling the search result from portions of matching candidate profile.

3. The method of claim 2, further comprising the step of determining the percentage of satisfaction of the match between the candidate profile and the search request.

4. The method of claim 2, wherein a candidate profile includes an exclusion list of one or more employers, the method further comprising the steps of:
a. determining whether the employer is indicated on the exclusion list; and
b. excluding all portions of the candidate profile from the search result upon determination that the employer is indicated on the exclusion list.

5. The method of claim 1, further comprising the steps of:
a. providing the candidate with a skills test;
b. receiving test results from the candidate;
c. generating a ranking based on the test results; and
d. associating at least one of the test results and the ranking with the candidate profile corresponding to the candidate.

6. The method of claim 5, further comprising the steps of:
a. receiving from the employer, a request to receive the ranking for at least one matched candidate;
b. charging the employer a fee based on the request to receive the ranking; and
c. providing the ranking of the matched candidates to the employer.

7. The method of claim 1, further comprising the steps of:
a. receiving a request from a candidate for training;
b . providing the requested training to the candidate; and
c. indicating the result of the training in the candidate profile corresponding to the candidate.

8. The method of claim 1, further comprising the steps of:
a. receiving a request from the employer for background check on a candidate; and
b. providing the employer with the background check on the candidate.

9. The method of claim 1, further comprising the steps of:
a. receiving a resume in electronic format from a candidate;
b. parsing the resume to identify information segments in the resume; and
c. generating a candidate profile by placing the identified segments in the corresponding profile format.

10. A method for matching candidates to available job openings, using a compilation of candidate profiles, comprising:
a. receiving from an employer a search request to be applied to the compilation of candidate profiles;
b. determining at least one matched candidate that corresponds to a candidate profile satisfying at least a portion of the search request;
c. providing to the employer at least a portion of the candidate profile corresponding to the at least one matched candidate,
d. receiving from the employer a request to receive identification data for at least one matched candidate; and
e. charging a fee to the employer based on the request to receive identification data; and
f. providing the employer with the requested identification data associated with the candidate profile corresponding to the at least one matched candidate.

11. The method of claim 10, wherein the step of providing at least a portion of the candidate profile further comprising the step of excluding identification data from the data provided.

12. A method for matching candidates to available job openings, using a compilation of candidate profiles, wherein the candidate profiles include identification data, comprising:
a. locking the identification data associated with each candidate profile;
b. upon request for identification data from an employer, unlocking the identification data associated with the candidate profile; and
c. charging a fee to the employer based on the request for identification data.

13. The method of claim 12, further comprising the steps of:
a. upon request for candidate profile from an employer, determining at least one matched candidate that corresponds to a candidate profile satisfying at least a portion of the request; and
b. providing to the employer access to the candidate profile corresponding to the at least one matched candidate.

14. A method for matching candidates to available job openings, comprising:
a. storing job profile data corresponding to a plurality of available job positions;
b. receiving a search request from a candidate to be applied to the job profile data;
c. displaying a search result to the candidate including a listing of at least one job opening that corresponds to a portion of the search request;
d. receiving, from the candidate, an indication of interest in at least one of the listed job openings;
e. transmitting candidate profile data corresponding to the candidate to an employer posting the indicated job listing;
f. receiving, from the employer, a request to receive identification data for the candidate; and
g. charging a fee to the employer based on the request to receive identification data.

15. The method of claim 14, further comprising the steps of
a. comparing each job profile to the search request;
b. determining a match when at least a portion of the job profile satisfies the search request; and
c. compiling the search result from portions of matching job profile.

16. The method of claim 15, further comprising the step of determining the percentage of satisfaction of the match between the job profile and the search request.

17. The method of claim 14, further comprising the steps of:
a. providing the candidate with a skills test;
b. receiving test results from the candidate;
c. generating a ranking based on the test results; and
d. associating at least one of the test results and the ranking with the candidate profile corresponding to the candidate.

18. The method of claim 17, further comprising the steps of:
a. receiving from the employer, a request to receive the ranking the candidate;
b. charging the employer a fee based on the request to receive the ranking; and
c. providing to the employer the ranking associated with the candidate profile corresponding to the candidate.

19. The method of claim 14, further comprising the steps of:
a. receiving a request from a candidate for training;
b . providing the requested training to the candidate; and
C. indicating the results of the training in the candidate profile corresponding to the candidate.

20. The method of claim 14, further comprising the steps of:
a. receiving a request from the employer for background check on a candidate; and
b. providing the employer with the background check on the candidate.

21. A method for matching candidates to available job openings, using a compilation of job profiles, comprising:
a. receiving from a candidate a criteria to be applied to the compilation of job profiles;
b. determining at least one matched job opening that corresponds to a job profile satisfying at least a portion of the criteria;
c. providing to the candidate at least a portion of the job profile corresponding to the at least one matched job opening,
d. receiving from the candidate an indication for at least one matched job opening;
e. providing to an employer at least a portion of a candidate profile wherein the employer is associated with the matched job opening and the candidate profile is associated with the candidate;
f. receiving from the employer a request to receive identification data for the received candidate profile; and
g. charging a fee to the employer based on the request to receive the identification data; and
h. providing the employer with the requested identification data associated with the candidate profile.

22. The method of claim 21, wherein the step of providing at least a portion of the candidate profile further comprising the step of excluding identification data from the profile provided.
